(19) United States
(12) Patent Application Publication
(10) Pub. No.: US 2011/0074344 A1
(43) Pub. Date: Mar. 31, 2011

(54) WIRELESS CHARGER USING INDUCTIVE COUPLING

(75) Inventors: Se-Ho PARK, Gyeonggi-do (KR); Young-Min Lee, Gyeonggi-do (KR); Sung-Kweon Park, Gyeonggi-do (KR); Ki-Hyun Kim, Gyeonggi-do (KR); Hong-Kweun Kim, Gyeonggi-do (KR); Woo-Ram Lee, Gyeonggi-do (KR)

(73) Assignee: Samsung Electronics Co., Ltd.

(21) Appl. No.: 12/893,619

(22) Filed: Sep. 29, 2010

(30) Foreign Application Priority Data
Sep. 29, 2009 (KR) 10-2009-0092202

(51) Int. Cl. H02J 7/00

(52) U.S. Cl. 320/108

(57) ABSTRACT

A wireless charger of an inductive coupling type for charging a portable device provided with a rechargeable built-in battery having a second coil, includes a housing provided with a touch pad on one surface; a first coil retained within the housing; and a driving means for horizontally moving the first coil in a plane parallel to the one surface on which the touch pad is installed, wherein when the portable device is placed on the touch pad, the touch pad senses the position of the portable device to activate the driving means and displaces the first coil to a position facing the second coil.

### PRIORITY

This application claims priority under 35 U.S.C. §119(a) to an application entitled “Wireless Charger Using Inductive Coupling” filed in the Korean Industrial Property Office on Sep. 29, 2009 and assigned Serial No. 10-2009-0092202, the contents of which are hereby incorporated by reference.

### BACKGROUND OF THE INVENTION

1. Field of the Invention

The present invention generally relates to a portable device such as a cellular phone, a portable game machine or a portable multimedia player, and more particularly to a wireless charger for a portable device provided with a built-in battery including a second coil.

2. Description of the Related Art

Generally, a portable device such as a cellular phone, a portable game machine or a Portable Multimedia Player (PMP) contains a battery for applying electrical power, which is substantially capable of repetitious charging and discharging.

In order to charge a rechargeable battery, it has been required to provide a mounting device on which the battery itself is seated and fixed to be charged, or the portable device containing the battery therein is mounted for being charged. As for a mounting type charger as the above, when the shape of the battery or the portable device is changed, the battery or the portable device having a different shape cannot be charged using the same mounting device. Hence, an individual mounting device must be provided for each battery or portable device, which results in inconvenience for a user to carry the individual mounting device. To resolve such inconvenience, there have been continuing efforts to provide a charger having a common, standardized charging terminal for a portable communication device such as the cellular phone or the like. However, it has drawbacks in that just such a charger itself is difficult to be used for charging different types of portable devices, such as game machines or PMPs.

Meanwhile, a wireless charger has recently appeared in the market, which is able to charge the built-in battery of the portable device wirelessly by providing a first coil to the charger and a second coil to the built-in battery of the portable device. Since the first and second coils should be substantially arranged in relation to each other so as to charge the portable device using the wireless charger, the user must place the portable device in a suitable position. In the meantime, despite the proper placement of the portable device by the user, if the position of the portable device is changed due to an impact or the like during the charging operation, the charging efficiency is rapidly lowered. Hence, a special structure to fix the portable device at the suitable position is generally employed, but in fact it still requires a separate charger having a specific shape corresponding to that of the battery or the portable device such as described above with respect to the mounting type charger.

In order to solve these drawbacks, a wireless charger has been designed to arrange the portable device using a magnetic substance. In other words, the magnetic substance is installed in the wireless charger, while a metal piece is attached to the portable device. The portable device is then arranged in a suitable position by attracting the metal piece with a pulling force of the magnetic substance. However, in consideration of the weight of the portable device itself, it needs a considerable magnetic force to arrange the portable device in a suitable position by using only the attractive force of the magnetic substance. Therefore, it has drawbacks in that this magnetic force not only affects the operational characteristics of the portable device, but also deteriorates the inductive coupling of the first and second coils. Moreover, when a geo-magnetic sensor, a gyro-sensor or the like is installed in the portable device, there is a risk that the magnetic force of the magnetic substance may induce malfunction of the portable device.

### SUMMARY OF THE INVENTION

Accordingly, the present invention has been made to solve the above-mentioned problems occurring in the prior art, and the present invention provides a wireless charger which can be commonly used for portable devices of various types provided with a rechargeable built-in battery including a second coil.

Further, the present invention provides a wireless charger which can be commonly used for different types of portable devices, thereby allowing a user to carry it with convenience.

Moreover, the present invention provides a wireless charger capable of improving charging efficiency during a charging operation by arranging a first coil in a suitable position regardless of the position of the portable device.

In accordance with an aspect of the present invention, there is provided a wireless charger of an inductive coupling type for charging a portable device provided with a rechargeable built-in battery having a second coil, the wireless charger including a housing provided with a touch pad on its one side; a first coil retained within the housing; and a driving means for horizontally moving the first coil in a plane parallel to a surface on which the touch pad is installed, wherein when the portable device is placed on the touch pad, the touch pad senses the position of the portable device to activate the driving means and displaces the first coil to a position facing the second coil.

The driving means includes a mount in which the first coil is installed; a first guide rail extending in a first direction and passing through the mount; and a second guide rail extending in a second direction perpendicular to the first direction and penetrating through the mount, wherein the first guide rail moves along the second direction within the housing while the second guide rail moves along the first direction within the housing, wherein the mount moves in the second direction together with the first guide rail under guidance of the second guide rail when the first guide rail moves along the second direction, and wherein the mount moves in the first direction together with the second guide rail under guidance of the first guide rail when the second guide rail moves along the first direction.

In addition, if two or more different portable devices are placed on the touch pad, the touch pad senses the position of each portable device to activate the driving means in turn, thereby charging the respective portable devices on the touch pad consecutively.

The wireless charger as described above is capable of arranging the first coil with the second coil provided in the built-in battery of the portable device regardless of the type of portable device that is placed on the touch pad, thereby improving efficiency during the charging operation. Further, it is noted that even though the position of the portable device may change while the portable device is being charged, it is possible to rearrange the position of the first coil, provided that the portable device still remains on the touch pad. In addition, when a plurality of portable devices are simultaneously placed on the touch pad or another portable device is located on the touch pad while one portable device is being charged, it is possible to consecutively proceed with the charging operation by arranging the first coil with the second coil provided in the additional portable device after the first portable device is completely charged. Therefore, it is advantageous in that even when the user carries a plurality of portable devices provided with the rechargeable built-in battery including a second coil, he or she can commonly use the wireless charger, which makes it easy to carry the portable device.

### BRIEF DESCRIPTION OF THE DRAWINGS

The above and other aspects, features and advantages of the present invention will be more apparent from the following detailed description taken in conjunction with the accompanying drawings, in which:

FIG. 1 is an exploded perspective view illustrating a wireless charger in accordance with an embodiment of the present invention;

FIG. 2 is a perspective view illustrating the wireless charger shown in FIG. 1;

FIG. 3 is a perspective view illustrating a portable device placed on the touch pad of the wireless charger shown in FIG. 2; and

FIG. 4 is a perspective view illustrating a first coil of the wireless charger shown in FIG. 3 arranged to face with a second coil of the portable device.

### DETAILED DESCRIPTION OF THE EMBODIMENTS OF THE PRESENT INVENTION

Hereinafter, embodiments of the present invention will be described with reference to the accompanying drawings. In the following description, a detailed description of known functions and configurations incorporated herein will be omitted when it may make the subject matter of the present invention unclear.

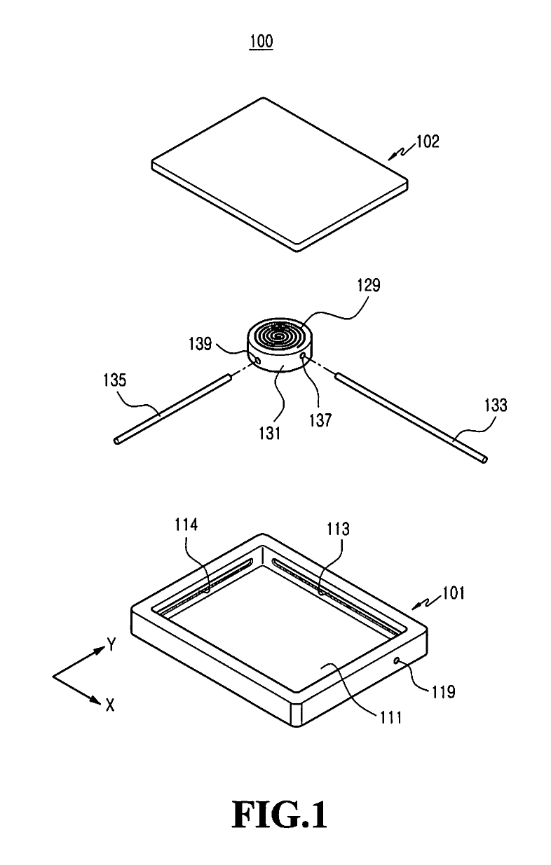

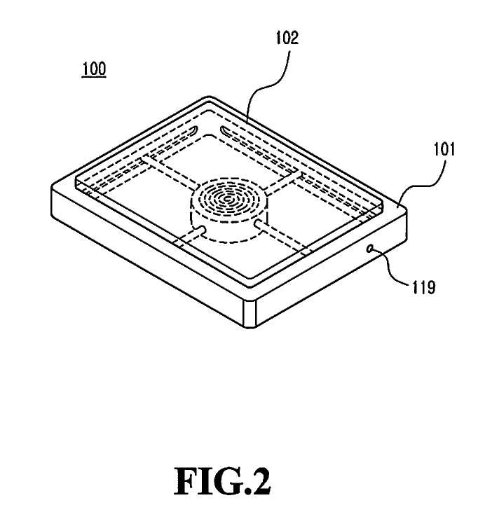

As shown in FIGS. 1 and 2, a wireless charger 100 in accordance with an embodiment of the present invention includes a touch pad 102 to sense the position of a portable device, in which a first coil 129 is retained within a housing 101 and displaceable in a first and a second (X, Y) direction through a driving means. A portable device provided with a built-in battery including a second coil is placed on the touch pad 102. The touch pad 102 is designed to sense the position of the portable device placed thereon and generate a signal to move the first coil 129.

The housing 101 includes a first guide groove 113 extending in the first direction X and a second guide groove 114 extending in the second direction Y on the inner wall of a rectangular inner space 111. Here, the first direction X coincides with a direction that one edge of the housing 101 extends to, while the second direction Y coincides with a direction that the other edge of the housing 101 extends to, which means a direction perpendicular to the first direction X.

The first guide groove 113 is formed on the opposite inner walls facing each other and extending in the first direction X within the inner space 111, respectively. Similarly, the second guide groove 114 is formed on the opposite inner walls facing each other and extending in the second direction Y in the inner space 111, respectively.

On the outer wall of the housing 101 is an indicator lamp 119 which is used as an alarming device. The indicator lamp 119 may consist of a light emitting diode (LED) generating red, yellow and blue light, and then indicates various states of the wireless charger 100 using its respective color. For instance, the indicator lamp 119 may illuminate in red light during the charging operation, illuminate in blue light upon completion of the charging operation, and illuminate or flicker in yellow light when the arrangement of the first coil 129 cannot be made because the portable device is placed on the outer periphery of the touch pad 102 or the like. Further, the indicator lamp 119 may flicker in blue light when at least one of the batteries completes its charging operation but the other battery is being charged in case that a plurality of portable devices are simultaneously placed on the touch pad 102. In addition to the indicator lamp 119, alternatively, the alarm device may be constructed using a speaker system or vibrator system.

The inner space 111 of the housing 101 is open toward the upper side of the housing 101, but the touch pad 102 is mounted on the upper side of the housing 101 to close the inner space 111. The touch pad 102 is constructed as a pressure sensor or the like. When the portable device is placed on the touch pad 102, the touch pad 102 senses the position of the portable device and generates a signal to move the first coil 129.

The first coil 129 horizontally moves in a plane parallel to the touch pad 102 within the inner space 111 of the housing 101. This is performed by the operation of the driving means which receives a signal from the touch pad 102. The driving means is composed of a mount 131 having the first coil 129 and first and second guide rails 133 and 135. Here, the driving means requires a driving element such as a piezoelectric element, a servo motor or the like for moving the first and second rails 133 and 135. This can be easily constructed by those skilled in the art, so detailed descriptions thereof will be omitted.

The first guide rail 133 extends in the first direction X, whose opposite ends are installed in the second guide groove 114 so that they are able to move along the second direction Y. In contrast, the second guide rail 135 extends in the second direction Y, and whose opposite ends are installed in the first guide groove 113 to move along the first direction X. In other words, the first guide rail 133 moves in the second direction Y, and the second guide rail 135 displaces in the first direction X within the inner space of the housing 101.

The first and second guide rails 133 and 135 pass through the mount 131, which is formed with guide holes 137 and 139 that the first and second guide rails 133 and 135 penetrate through. Accordingly, the mount 131 is displaceable in the second direction Y along with the first guide rail 133 or in the first direction X together with the second guide rail 135. When the mount 131 moves in the second direction Y, it slidably moves along the second guide rail 135 under the guidance of the second guide rail 135. Similarly, when the mount 131 moves in the first direction X, it slides along the first guide rail 133 with help of the first guide rail 133. Hence, even if the portable device is placed at any position on the touch pad 102, the first coil 129 can be moved within the inner space 111 of the housing 101 and then arranged with the second coil which is contained in the built-in battery of the portable device located on the touch pad 102.

Meanwhile, it is preferable for an item placed on the touch pad 102 to be provided with a sensor and a control circuit to recognize the rechargeability, check the completion of the charging operation, or detect abnormal changes of voltage, temperature or the like during the charging operation. This can be achieved by using a carrier current flowing between the first coil 129 and the second coil installed in the built-in battery.

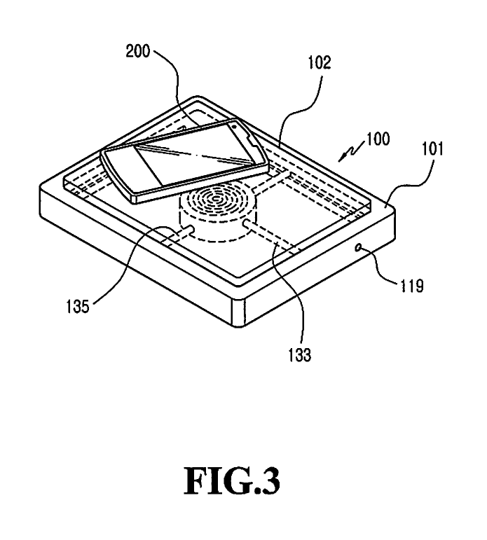

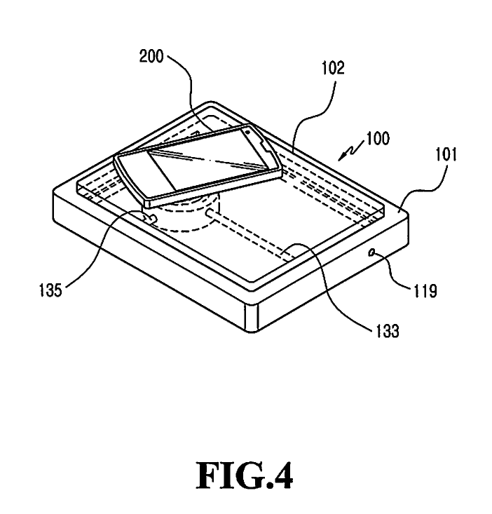

FIGS. 3 and 4 illustrate the charging operation of the portable device using the wireless charger 100 as described above.

First, referring to FIG. 3, the user may put the portable device 200 onto the touch pad 102 at any position. Even though it may be preferable for the user to locate the second coil contained in the built-in battery of the portable device 200 in a position arranged with the first coil 129, it is not necessary. When the position of the portable device 200 is detected by the touch pad 102, the wireless charger 100 moves the first coil 129 using a control program installed therein. As mentioned above, the first and second guide rails 133 and 135 of the driving means start to move and arrange the first coil 129 to face the second coil. The first and second guide rails 133 and 135 may be displaced simultaneously or consecutively.

FIG. 4 illustrates a state where the first coil 129 has been moved and is now arranged with the second coil of the built-in battery of the portable device 200. During the charging operation, when the portable device 200 is displaced on the touch pad 102 by the external factors such as impacts or the like, the touch pad 102 again detects the position of the portable device 200 and generates a signal to move the first coil 129 accordingly.

Moreover, in the process of charging a first portable device 200, when another portable device is placed on the touch pad 102, the touch pad 102 then senses the position of the second portable device 200, and moves the first coil 129 to be arranged with the second portable device 200 for charging the same after completion of the first portable device 200.

While the invention has been shown and described with reference to certain embodiments thereof, it will be understood by those skilled in the art that various changes in form and details may be made therein without departing from the spirit and scope of the invention as defined by the appended claims.

What is claimed is:

1. A wireless charger of an inductive coupling type for charging a portable device provided with a rechargeable built-in battery having a second coil, comprising:
a housing provided with a touch pad on one surface;
a first coil retained within the housing; and
a driving means for horizontally moving the first coil in a plane parallel to the one surface on which the touch pad is installed,
wherein when the portable device is placed on the touch pad, the touch pad senses a position of the portable device to activate the driving means and displaces the first coil to a position facing the second coil.

2. The wireless charger as recited in claim 1, wherein the driving means comprises:
a mount in which the first coil is installed;
a first guide rail extending in a first direction and passing through the mount; and
a second guide rail extending in a second direction perpendicular to the first direction and passing through the mount,
wherein the first guide rail moves along the second direction within the housing and the second guide rail moves along the first direction within the housing, wherein the mount moves in the second direction together with the first guide rail under the guidance of the second guide rail when the first guide rail moves along the second direction, and wherein the mount moves in the first direction together with the second guide rail under the guidance of the first guide rail when the second guide rail moves along the first direction.

3. The wireless charger as recited in claim 1, further comprising an alarm device for providing a warning signal when the portable device is located on an outer periphery of the touch pad.

4. The wireless charger as recited in claim 1, wherein when two or more different portable devices are placed on the touch pad, the touch pad senses the position of each portable device to activate the driving means in turn, thereby charging the portable devices on the touch pad consecutively.

5. The wireless charger as recited in claim 1, wherein when a second portable device is placed on the touch pad during the charging operation of a first portable device, the touch pad senses a position of the second portable device and then activates the driving means to move the first coil to a position facing the second coil of the second portable device upon completion of the charging operation the first portable device.
